(19) United States
(12) Patent Application Publication
(10) Pub. No.: US 2015/0371221 A1
(43) Pub. Date: Dec. 24, 2015

(54) TWO FACTOR AUTHENTICATION FOR INVOICING PAYMENTS

(71) Applicant: Ebay Inc., San Jose, CA (US)

(72) Inventor: Bradley Wardman, Phoenix, AZ (US)

(21) Appl. No.: 14/311,119

(22) Filed: Jun. 20, 2014

(51) Int. Cl. G06Q 20/36; G06Q 30/04

(52) U.S. Cl. CPC G06Q 20/3674; G06Q 30/04

(57) ABSTRACT

Methods and systems for authenticating a transaction are described. A user provides a user account and contact information to a merchant, and the merchant transmits this information to a service provider. The service provider generates an access token for the transaction and sends it to the contact information. The service provider also sends a notification to the user account. The user provides the access token to the service provider. The service provider confirms the access token, and processes the payment.

### BACKGROUND

1. Field of the Invention

The present invention generally relates to authenticating transactions, and more particularly to using an access token to authenticate transactions without providing a funding source number.

2. Related Art

Typically, for purchases made online, by phone, or by mail, a buyer provides account information of a payment card (e.g., bank or credit card company issued credit card or debit card), including a payment card number and other account information, such as a security code, expiration date of payment card, and billing address. For purchases made in person at a point of sale (POS), a buyer presents a payment card to a merchant, who swipes or scans the card to access the account information, and the buyer may also be required to provide a signature or enter a personal identification number (PIN).

Buyers, however, may wish to make purchases without providing account information of a payment card to a merchant. By providing payment card information to a merchant, a buyer is vulnerable to eavesdropping by an attacker, who may obtain the payment card information and use it for illegitimate purposes, such as identity theft. The attacker may intercept not only the payment card information, but also security information, such as the security code, personal identification number (PIN), or billing address.

When paying online, a buyer may be a victim of a “man-in-the-middle attack,” in which an attacker eavesdrops by intercepting electronic communications. An attacker may make independent network connections with a buyer and a merchant and control the conversation between them, such as intercept messages and/or deliver false messages. Because the buyer believes he or she is communicating directly with the merchant, the buyer may provide payment card information, which the attacker may intercept. With respect to emails, a buyer may be a victim of an email spoofing attack. An attacker may send an email pretending to be a merchant and requesting payment. The buyer may click on a link in the email and be redirected to a false merchant webpage, and the attacker may get information entered by the buyer.

When communicating the information over the phone, an attacker may wiretap and listen in on a call. Even when paying in person, payment card information may be compromised. The credit or debit card information may be recorded, such as on a physical receipt or on a computer database, and an attacker may see or otherwise misappropriate the information.

Thus, a need exists for systems and methods that allow a buyer to make secure payments without providing sensitive card account information.

### BRIEF DESCRIPTION OF THE FIGURES

FIG. 1 is a block diagram illustrating a system for authenticating a transaction according to an embodiment of the present disclosure;

FIG. 2 is a flowchart showing a method for authenticating a transaction according to an embodiment of the present disclosure; and

FIG. 3 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes systems and methods that provide for two-factor authentication of a transaction. When a user makes a purchase, instead of providing a payment card number, the user provides a merchant with two pieces of information—an account identifier associated with the user and a method of contact (e.g., phone number, fax number, mobile phone number, email address, home address, business address, etc.). In one embodiment, the account identifier is not an actual funding source (such as a credit card or debit card) number, but instead is an email address, phone number, or other information that identifies a user's account with a service provider. The merchant sends or otherwise provides the account information and the contact information to a service provider as part of a payment request on behalf of the user. In some embodiments, the merchant enters the account and contact information on a service provider page. The service provider receives the information, locates the user's account, and if the payment request can be approved, generates an access token, e.g., an access code, such as a numeric string, alpha string, or an alphanumeric string. In one embodiment, the access code includes a random selection of letters, numbers, and/or other types of characters such as symbols (e.g., punctuation marks). In some embodiments, the access code consists of two to sixteen characters, although different code lengths are also possible. In exemplary embodiments, the access code consists of six characters.

The service provider sends or otherwise provides the access token to the contact information provided by the user, and also sends a notification to the user's service provider account. In various embodiments, the service provider additionally sends the access token to the merchant, and the merchant provides the user with the access token so that the user can compare the token received from the merchant with the one received from the service provider to further verify the authenticity of the merchant. The user provides the access token to the service provider, confirming that the user authorizes the transaction and authenticating the transaction with the service provider. In exemplary embodiments, the service provider processes the payment from the user's service provider account. Thus, a consumer can make a purchase using a funding source without having to provide sensitive information to a merchant.

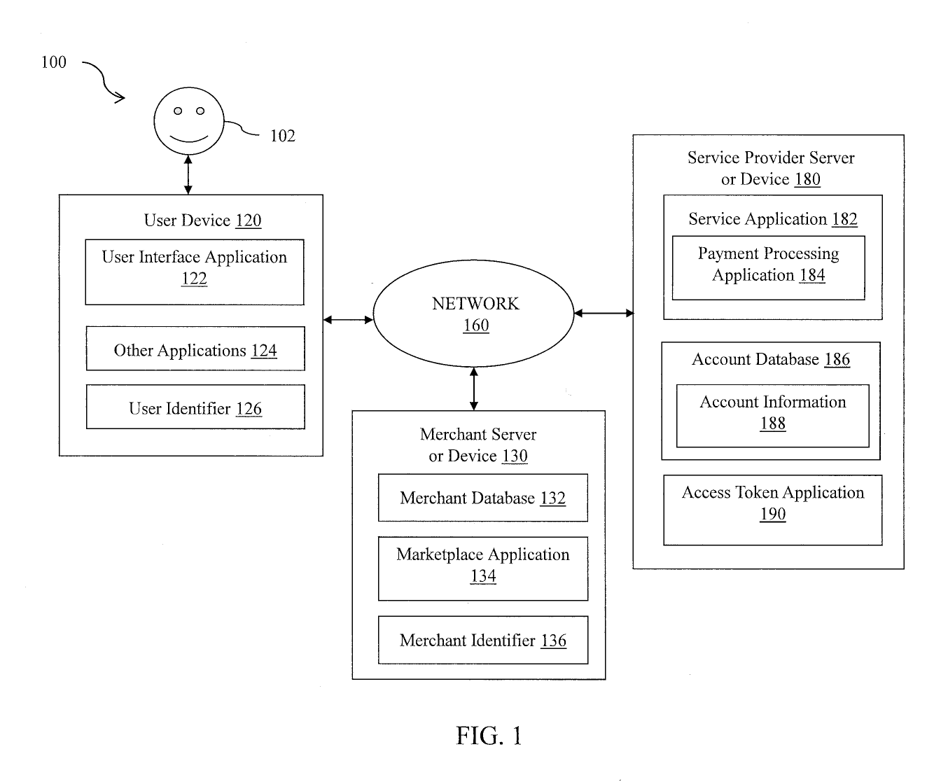

FIG. 1 shows one embodiment of a block diagram of a network-based system 100 adapted to authenticate payment with a user device 120 over a network 160. As shown, system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 1, the system 100 includes a user device 120 (e.g., a smartphone), one or more merchant servers or devices 130 (e.g., network server devices), and at least one service provider server or device 180 (e.g., network server device) in communication over the network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 120, in one embodiment, may be utilized by the user 102 to interact with the merchant server or device 130 and/or the service provider server 180 over the network 160. For example, the user 102 may conduct financial transactions (e.g., account transfers) with the service provider server 180 via the user device 120. The user device 120, in various embodiments, may be implemented using any appropriate combination of hardware and/or software configured for wired and/or wireless communication over the network 160. In various implementations, the user device 120 includes a wireless telephone (e.g., cellular or mobile phone), a tablet, a personal computer, a notebook computer, a wearable computing device, and/or various other generally known types of wired and/or wireless computing devices.

The user device 120, in one embodiment, includes a user interface application 122, which may be utilized by the user 102 to conduct transactions (e.g., shopping, purchasing, bidding, etc.) with the merchant server or device 130 and/or service provider server 180 over the network 160. In one aspect, purchase expenses may be directly and/or automatically debited from an account related to the user 102 via the user interface application 122.

In one implementation, the user interface application 122 comprises a software program, such as a graphical user interface (GUI), executable by a processor that is configured to interface and communicate with the service provider server 180 via the network 160. In another implementation, the user interface application 122 comprises a browser module that provides a network interface to browse information available over the network 160. For example, the user interface application 122 may be implemented, in part, as a web browser to view information available over the network 160.

In an example, the user 102 is able to access merchant websites via the one or more merchant servers 130 to view and select items for purchase, and the user 102 is able to purchase items from the one or more merchant servers 130 via the service provider server 180. Accordingly, in one or more embodiments, the user 102 may conduct transactions (e.g., purchase and provide payment for one or more items) from the one or more merchant servers 130 via the service provider server 180.

The user device 120, in various embodiments, may include other applications 124 as may be desired in one or more embodiments of the present disclosure to provide additional features available to user 102. In one example, such other applications 124 may include security applications for implementing client-side security features, programmatic client applications for interfacing with appropriate application programming interfaces (APIs) over the network 160, and/or various other types of generally known programs and/or software applications. In still other examples, the other applications 124 may interface with the user interface application 122 for improved efficiency and convenience.

In various implementations, a user profile may be created using data and information obtained from cell phone activity over the network 160. Cell phone activity transactions may be used by the service provider server 180 to create at least one user profile for the user 102 based on activity from the user device 120 (e.g., cell phone). The user profile may be updated with each financial and/or information transaction (e.g., payment transaction, purchase transaction, etc.) achieved through use of the user device 120. In various aspects, this may include the type of transaction and/or the location information from the user device 120. As such, the profile may be used for recognizing patterns of potential fraud, setting transaction limits on the user, etc.

The user device 120, in one embodiment, may include at least one user identifier 126, which may be implemented, for example, as operating system registry entries, cookies associated with the user interface application 122, identifiers associated with hardware of the user device 120, or various other appropriate identifiers. The user identifier 126 may include one or more attributes related to the user 102, such as personal information related to the user 102 (e.g., one or more user names, passwords, photograph images, biometric IDs, addresses, phone numbers, social security number, etc.) and banking information and/or funding sources (e.g., one or more banking institutions, credit card issuers, user account numbers, security data and information, etc.). In various implementations, the user identifier 126 may be passed with a user login request to the service provider server 180 via the network 160, and the user identifier 126 may be used by the service provider server 180 to associate the user 102 with a particular user account maintained by the service provider server 180.

The one or more merchant servers 130, in various embodiments, may be maintained by one or more business entities (or in some cases, by a partner of a business entity that processes transactions on behalf of business entities). Examples of business entities include merchant websites, resource information websites, utility websites, real estate management websites, social networking websites, etc., which offer various items for purchase and payment. In some embodiments, business entities may need registration of the user identity information as part of offering items to the user 102 over the network 160. As such, each of the one or more merchant servers 130 may include a merchant database 132 for identifying available items, which may be made available to the user device 120 for viewing and purchase by the user 102. In one or more embodiments, user 102 may complete a transaction such as purchasing the items via service provider server 180.

Each of the merchant servers 130, in one embodiment, may include a marketplace application 134, which may be configured to provide information over the network 160 to the user interface application 122 of the user device 120. For example, user 102 may interact with the marketplace application 134 through the user interface application 122 over the network 160 to search and view various items available for purchase in the merchant database 132.

Each of the merchant servers 130, in one embodiment, may include at least one merchant identifier 136, which may be included as part of the one or more items made available for purchase so that, e.g., particular items are associated with particular merchants. In one implementation, the merchant identifier 136 may include one or more attributes and/or parameters related to the merchant, such as business and banking information. The merchant identifier 136 may include attributes related to the merchant server or device 130, such as identification information (e.g., a serial number, a location address, GPS coordinates, a network identification number, etc.). In various embodiments, user 102 may conduct transactions (e.g., searching, selection, monitoring, purchasing, and/or providing payment for items) with each merchant server 130 via the service provider server 180 over the network 160.

A merchant website may also communicate (for example, using merchant server 130) with the service provider through service provider server 180 over network 160. For example, the merchant website may communicate with the service provider in the course of various services offered by the service provider to a merchant website, such as payment intermediary between customers of the merchant website and the merchant website itself. For example, the merchant website may use an application programming interface (API) that allows it to offer sale of goods in which customers are allowed to make payment through the service provider, while user 102 may have an account with the service provider that allows user 102 to use the service provider for making payments to merchants that allow use of authentication, authorization, and payment services of the service provider as a payment intermediary. The merchant website may also have an account with the service provider.

The service provider server 180, in one embodiment, may be maintained by a transaction processing entity or an online service provider, which may provide processing for financial transactions and/or information transactions between the user 102 and one or more of the merchant servers 130. As such, the service provider server 180 includes a service application 182, which may be adapted to interact with the user device 120 over the network 160 to facilitate the searching, selection, purchase, and/or payment of items by the user 102 from the one or more merchant servers 130. In one example, the service provider server 180 may be provided by PayPal®, Inc., eBay® of San Jose, Calif., USA, and/or one or more financial institutions or a respective intermediary that may provide multiple point of sale devices at various locations to facilitate transaction routings between merchants and, for example, financial institutions.

The service application 182, in one embodiment, utilizes a payment processing application 184 to process purchases and/or payments for financial transactions between the user 102 and each of the merchant servers 130. In one implementation, the payment processing application 184 assists with resolving financial transactions through validation, delivery, and settlement. As such, the service application 182 in conjunction with the payment processing module 184 settles indebtedness between the user 102 and each of the merchant servers 130, wherein accounts may be directly and/or automatically debited and/or credited of monetary funds in a manner as accepted by the banking industry.

The service provider server 180, in one embodiment, may be configured to maintain one or more user accounts and merchant accounts in an account database 186, each of which may include account information 188 associated with one or more individual users (e.g., user 102) and merchants. For example, account information 188 may include private financial information of user 102 and merchants (e.g., one or more merchants associated with merchant servers 130), such as one or more account numbers, passwords, credit card information, banking information, or other types of financial information, which may be used to facilitate financial transactions between user 102, and one or more merchants associated with the merchant servers 130. The account information 188 may also include personal information, such as one or more contact information (e.g., phone number, address, email, etc.) and other account IDs of the user 102 that are maintained by third parties (e.g., user names or account numbers). In various aspects, the methods and systems described herein may be modified to accommodate users and/or merchants that may or may not be associated with at least one existing user account and/or merchant account, respectively.

In one implementation, the user 102 may have identity attributes stored with the service provider server 180, and user 102 may have credentials to authenticate or verify identity with the service provider server 180. User attributes may include personal information, banking information and/or funding sources. In various aspects, the user attributes may be passed to the service provider server 180 as part of a login, search, selection, purchase, and/or payment request, and the user attributes may be utilized by the service provider server 180 to associate user 102 with one or more particular user accounts maintained by the service provider server 180.

In various embodiments, the service provider server 180 includes an access token application 190. The access token application 190 receives a user's account information and contact information from a merchant for a transaction, and generates an access token associated with the transaction. The access token may be an access code that includes letters, numbers, and/or other types of symbols (e.g., punctuation marks). In some embodiments, the access token is only valid for a specific transaction (e.g., transaction amount, item purchased, date purchased, etc.) and the parties to the transaction (i.e., user 102 and the merchant). The access token is transmitted to the contact information of the user 102 and a notification of the transaction is sent to the user's service provider account.

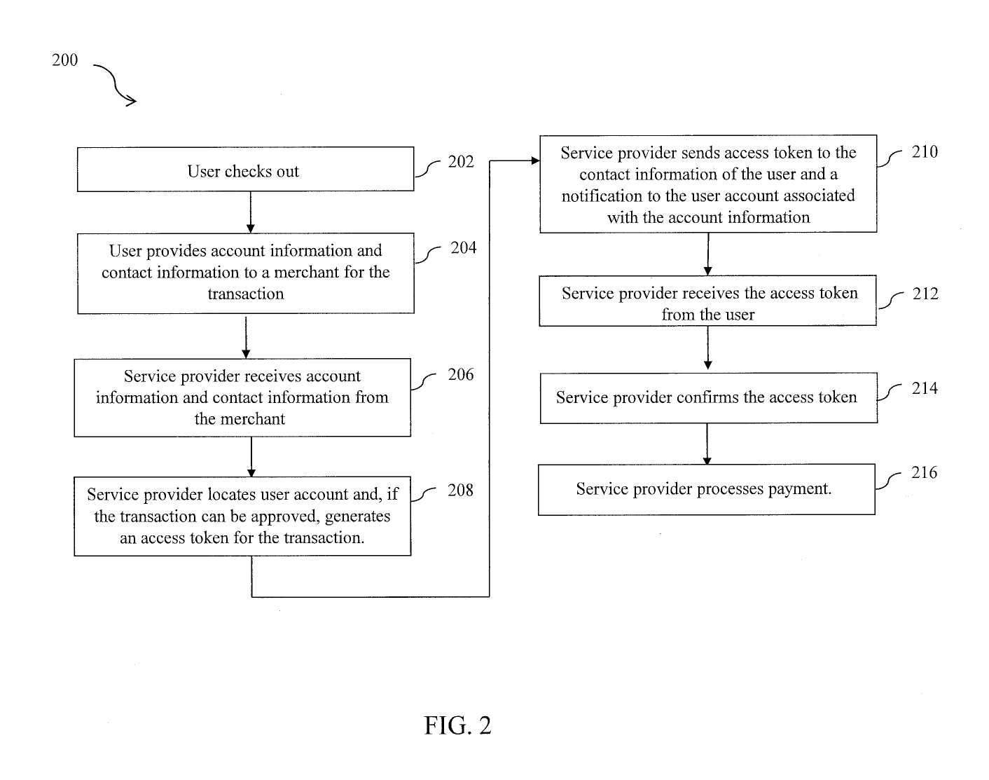

Referring now to FIG. 2, a flowchart 200 of a method for authenticating a transaction is illustrated according to an embodiment of the present disclosure. In various embodiments, the user 102 registers with a service provider, such as a payment services provider. Registration may include signing up for the service and agreeing to any terms required by the service provider, such as through user device 120. In one embodiment, the user device 120 is a mobile computing device, such as a smart phone, a PC, or a computing tablet. In other embodiments, registration may be done completely through the user device 120, partially through the user device 120, or without using the user device 120, such as through a phone call or in-person visit to a representative of the service provider.

The user 102 may be requested to provider specific information for registration, such as, but not limited to, a name, address, phone number, email address, picture, a username for the account, and a password or PIN for the account. The type of information requested may depend on whether the user 102 already has an account with the service provider. Requested information may be entered through the user device 120 or other means, including voice or manual key entry. Once all the requested information is received and confirmed, the service provider may create an account for the user 102.

In some embodiments, the user 102 is requested to enter funding sources for the user account. Funding sources include, for example, a credit card or debit card (e.g., Visa®, MasterCard®, Capital One®, Discover® or American Express® card, or), a bank account (e.g., Wells Fargo or Bank of America® checking account), a gift card (e.g., Wal-Mart gift card), prepaid card, line-of-credit, check, money order, etc. The user 102 has the option of adding further funding sources, or to edit or delete existing funding sources. In some embodiments, the user 102 selects a primary or default funding source.

At step 202, the user 102 goes through a conventional checkout process. For example, the user 102 may access a merchant website, seller website, marketplace website, or other website or mobile application that enables a user to shop and make a purchase. Access may be through a PC, computing tablet, smart phone, or other computing device. The purchase may be items, physical goods, digital goods, donations, services, etc. The shopping and purchase process may also be at a physical merchant location or through a phone call with a representative of a seller.

The user 102 then selects desired items for purchase. Note that items, as used herein, may include one or more of the different purchases listed above. The selected items may be placed in a cart, which the user 102 can review and edit if needed. The user 102 may then confirm the order. Before confirmation, the user 102 may be presented with details of the purchase, such as item description, item prices, total price, shipping costs, tax, etc. If the details are acceptable and correct, the user 102 may select a “Confirm,” “Pay,” or other button or link to confirm the order. If the purchase is at the merchant POS, the items may be scanned and totaled. If the purchase is through a phone call, the items may be identified through an Interactive Voice Response (IVR) system or through item identification and confirmation with a live representative.

At step 204, the user 102 is ready to make a payment and provides two pieces of information to the merchant during checkout: (1) an account identifier associated with the user 102 and (2) contact information associated with the user 102. The user 102 does not provide funding source information such as payment card number, security code, or expiration date of payment card. The account identifier may be any financial account associated with the user 102, such as a bank account, credit card account, or service provider account. The user 102 provides an account by providing account information that identifies a user account. In one embodiment, the user 102 may provide the account ID of the user account (e.g., a username, a phone number, or an email address used as a username). Additionally, the user 102 may provide the name of the company that holds the account. For example, the user 102 may specify that he or she has an account with Bank of America®, Visa®, MasterCard®, or PayPal®.

The user 102 also provides contact information (e.g., email, phone number, address, etc.), where the user 102 can be reached. In some embodiments, the user 102 selects a method of contact that the user 102 previously provided to the service provider as part of the registration process, which is stored by the service provider server 180 in the account database 186. In some embodiments, the contact information is not provided if it was provided as part of the account identifier information (e.g., mobile phone number or email address).

In one embodiment, the information is communicated to the merchant through voice, e.g., the user 102 telling the merchant the information over the phone. In another embodiment, the user 102 enters the two pieces of information through the merchant site, seller site, marketplace site, or other site or mobile app. In some embodiments, the user 102 provides the information in the same manner that the user checked out the items, for example, on a user device, by phone, or in person.

At step 206, the merchant receives the account information and the contact information, sends them to the service provider server 180, and the service provider server 180 receives the two pieces of information. In one embodiment, the merchant enters the two pieces of information into a field on a payment method screen provided by the service provider, which is transmitted over the network 160 to the service provider server 180. In another embodiment, the two pieces of information are passed to the merchant server 130, which then passes the information on to the service provider server 180. In a further embodiment, in which the two pieces of information are communicated to the merchant over the phone, the merchant can call the service provider to provide the information or enter it on a merchant device which communicates the information to the service provider server 180. In some embodiments, the merchant may also include details of the transaction, such as merchant identifier, a merchant account number with the service provider, a merchant account number with a bank, total purchase account, item descriptions, item costs, item identifiers, etc.

At step 208, the service provider server 180 locates the user account using the received information. Once the user account is accessed, the service provider determines whether there are any restrictions or limitations that would prevent the user from making this purchase. For example, the account may be inactive, have expired funding sources, reached transaction or dollar limits, etc. If the payment request can be approved, the service provider server 180 generates an access token for the transaction. The access token, in one embodiment, includes a random selection of numbers, letters, and symbols. In some exemplary embodiments, the access token may be a random one-time use code that is generated by the service provider executing a random character generation program. For example, the access token may also only be used for one specific transaction between the user 102 and the merchant. In various embodiments, the access token is valid for a limited amount of time for increased security. For example, the user 102 may only have a predetermined amount of time to provide the access token to the service provider to confirm and pay for the transaction. In some embodiments, the expiration time is variable, such as based on amount of payment request, location of user, type of merchant or purchase, and/or other factors that may affect security. For example, a shorter expiration time may be associated with a token having a higher payment approval amount than a token with a lower payment approval amount. After the amount of time has passed, the user 102 may have to go through the checkout process again so that the service provider server 180 can generate another access token. Tokens may also have other restrictions. Tokens may be one-time use tokens or limited to a specific number of uses with a merchant within a certain time period.

In exemplary embodiments, the access token binds the user 102 to the merchant. That is, the access token may only be used in transactions between the user 102 and that merchant. For example, if the user 102 has dealings with another merchant and attempts to use the access token to authorize a transaction with the other merchant, the access token cannot be validated by the service provider, and the transaction will be denied. Because the access token links the user 102 and a specific merchant by limiting the access token to be only used in a transaction between the user 102 and the specific merchant, man-in-the-middle attacks are further prevented. An attacker in a man-in-the-middle attack may attempt to eavesdrop and intercept electronic communications between the user 102 and the specific merchant, and/or electronic communications between the user 102 and the service provider. However, even if the attacker intercepts the access token from a communication to or from the user, the access token is only valid for the transactions between the user 102 and the specific merchant, and cannot be used for any other transaction. Thus, the attacker cannot use the access token to redirect the user's money into another account.

At step 210, the service provider server 180 sends the access token to the contact information of the user 102. The access token is sent, for example, in an email message or to a phone number in a text, by an automated voice message, or by a live call from a representative. The service provider server 180 also sends a notification to the user account associated with the account information. For example, the notification includes a message such as, “You owe $20 to Target. Check your email to obtain the access token.” The notification may also include a box or field for the user 102 to enter the access token to confirm and authorize the transaction. Thus, not only must the user 102 have the correct access token, the access token must be entered in a notification sent to the user account. In various embodiments, the user account is an account maintained by the service provider. For example, the service provider may send a notification to the primary email address on the user account depending on the user's notification preference, and also place the notification on the user's service provider page so that the user 102 sees the notification when he or she logs in to the service provider. In exemplary embodiments, the service provider server 180 does not send the access token to the user account, but the access token is only sent to the contact information of the user 102.

In certain embodiments, the service provider also sends the access token to the merchant, requests that the merchant communicate the access token to the user 102, and the merchant can tell the user 102 the access token, for example, over the phone for added security. The merchant-provided access token confirms the access token received by the user 102. For example, the user 102 can compare the access token provided by the merchant and the access token provided to the user 102 by the service provider server 180.

In certain embodiments, the user 102 may select the contact information associated with a user account maintained by the service provider and specify the preferred method of contact (e.g., email, phone, mail, text, push notification, etc.) for receiving the access token. For example, the user 102 may want to be contacted by text to a number stored in the user's service provider account. Similarly, in some embodiments, the merchant can select to use an existing email or an existing phone number associated with a user account maintained by the service provider server 180 when providing the contact information to the service provider. The merchant can indicate this method of contact on the payment method page in the merchant's service provider account.

At step 212, the service provider server 180 receives the access token from the user 102. In various embodiments, the user 102 enters the access token into a field on a user interface application 122, such as the service provider's webpage, which transmits the access token over the network 160 to the service provider server 180. For example, the user 102 may log on to the user's service provider account, find the notification sent by the service provider, find the relevant transaction, see the money requested by the merchant, and enter the access token to approve the transaction. In other embodiments, the user 102 provides the access token to the service provider by phone, such as through an Interactive Voice Response (IVR) system or a live representative.

At step 214, the service provider server 180 confirms the access token by, for example, comparing it with the access token that was generated and sent to the user 102. In various embodiments, the service provider server 180 checks the user 102, merchant, and transaction associated with the access token provided by the user 102 to see that it corresponds to the correct user 102, merchant, and transaction.

When the access token is confirmed, at step 216, the service provider server 180 approves and processes the payment request. For example, a user account is deducted a transaction amount, and a merchant account is credited the transaction amount. After processing, the service provider server 180 may transmit a notification to the user 102 and/or the merchant.

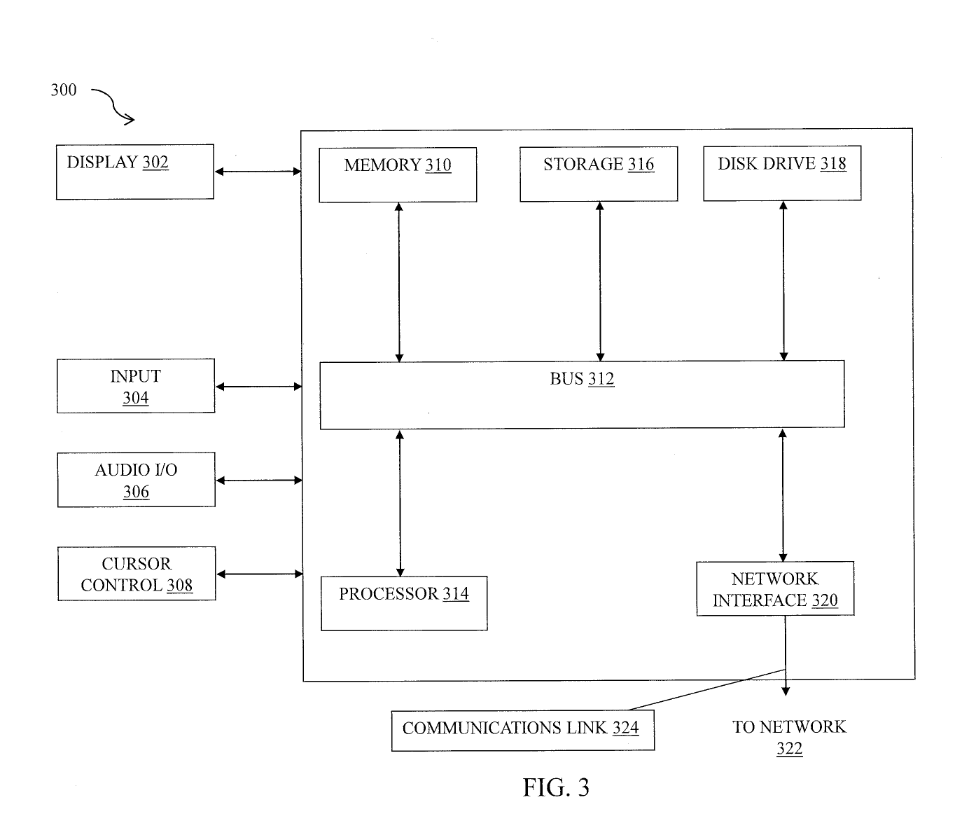

FIG. 3 is a block diagram of a computer system 300 suitable for implementing one or more embodiments of the present disclosure, including the user device 120, merchant server 130, and the service provider server 180. In various implementations, the user device 120 may comprise a mobile cellular phone, personal computer (PC), laptop, wearable computing device, etc. adapted for wireless communication, and the merchant server 130 and service provider server 180 may comprise a network computing device, such as a server. Thus, it should be appreciated that the devices 120, 130, and 180 may be implemented as computer system 300 in a manner as follows.

Computer system 300 includes a bus 312 or other communication mechanism for communicating information data, signals, and information between various components of computer system 300. Components include an input/output (I/O) component 304 that processes a user (i.e., sender, recipient, service provider) action, such as selecting keys from a keypad/keyboard, selecting one or more buttons or links, etc., and sends a corresponding signal to bus 312. I/O component 304 may also include an output component, such as a display 302 and a cursor control 308 (such as a keyboard, keypad, mouse, etc.). An optional audio input/output component 306 may also be included to allow a user to use voice for inputting information by converting audio signals. Audio I/O component 306 may allow the user to hear audio. A transceiver or network interface 320 transmits and receives signals between computer system 300 and other devices, such as another user device, a merchant server, or a service provider server via network 322. In one embodiment, the transmission is wireless, although other transmission mediums and methods may also be suitable. A processor 314, which can be a micro-controller, digital signal processor (DSP), or other processing component, processes these various signals, such as for display on computer system 300 or transmission to other devices via a communication link 324. Processor 314 may also control transmission of information, such as cookies or IP addresses, to other devices.

Components of computer system 300 also include a system memory component 310 (e.g., RAM), a static storage component 316 (e.g., ROM), and/or a disk drive 318. Computer system 300 performs specific operations by processor 314 and other components by executing one or more sequences of instructions contained in system memory component 310. Logic may be encoded in a computer readable medium, which may refer to any medium that participates in providing instructions to processor 314 for execution. Such a medium may take many forms, including but not limited to, non-volatile media, volatile media, and transmission media. In various implementations, non-volatile media includes optical or magnetic disks, volatile media includes dynamic memory, such as system memory component 310, and transmission media includes coaxial cables, copper wire, and fiber optics, including wires that comprise bus 312. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 300. In various other embodiments of the present disclosure, a plurality of computer systems 300 coupled by communication link 324 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a memory storing user account information; and
one or more processors in communication with the memory and operable to:
receive, from a merchant for a transaction, account information for a user account and contact information for a user;
generate an access token for the transaction;
transmit the access token to the contact information;
transmit a notification to the user account;
receive the access token from the user;
confirm that the access token received from the user matches the access token generated; and
process the payment.

2. The system of claim 1, wherein the access token is not transmitted to the user account.

3. The system of claim 1, wherein the user enters the access token in the notification.

4. The system of claim 1, wherein the one or more processors is further operable to transmit the access token to the merchant.

5. The system of claim 4, wherein the merchant transmits the access token to the user.

6. The system of claim 1, wherein the account information, the contact information, or the access token is communicated to or from the user by voice or in person.

7. The system of claim 1, wherein the access token is associated with a particular user, a particular merchant, or both.

8. The system of claim 1, wherein the access token is valid for one-time use, a specific number of uses, a predetermined amount of time, or a variable amount of time.

9. A method for authenticating a transaction, comprising:
receiving, by one or more hardware processors of a service provider, a payment request from a merchant, wherein the payment request includes an account identifier for a user account and contact information for a user;
generating, by the one or more hardware processors, an access token for the payment request;
transmitting, by the one or more hardware processors, the access token to the user at the contact information;
transmitting, by the one or more hardware processors, a notification to the user account;
receiving, by the one or more hardware processors, the access token from the user;
confirming, by the one or more hardware processors, that the access token received from the user matches the access token generated; and
processing, by the one or more hardware processors, the payment request.

10. The method of claim 9, wherein the account identifier, the contact information, or the access token is communicated to or from the user by voice or in person.

11. The method of claim 9, wherein the access token is valid for a particular transaction, particular user, particular merchant, or any combination thereof.

12. The method of claim 9, further comprising transmitting the access token to the merchant and notifying the merchant to provide the access token to the user.

13. The method of claim 12, wherein the user compares the access token provided by the merchant with the access token received.

14. The method of claim 9, wherein the user enters the access token in the notification.

15. A non-transitory machine-readable medium comprising instructions which, in response to a computer system, cause the computer system to perform a method comprising:
receiving a payment request from a merchant on a payment method screen provided by a service provider, wherein the payment request includes account information for a user account and contact information for a user;
generating an access token for the payment request;
transmitting the access token to the contact information;
transmitting a notification to the user account;
receiving the access token from the user in the notification;
confirming that the access token received from the user matches the access token generated; and
processing the payment request.

16. The non-transitory machine-readable medium of claim 15, wherein the account information, contact information, or access token is communicated to or from the user by voice or in person.

17. The non-transitory machine-readable medium of claim 15, wherein the access token is not transmitted to the user account.

18. The non-transitory machine-readable medium of claim 15, wherein the access token binds the user to the merchant.

19. The non-transitory machine-readable medium of claim 15, wherein the method further comprises transmitting the access token to the merchant.

20. The non-transitory machine-readable medium of claim 19, wherein the merchant transmits the access token to the user.
